(19) United States
(12) Patent Application Publication
(10) Pub. No.: US 2020/0091491 A1
(43) Pub. Date: Mar. 19, 2020

(54) Storage Cell for Storing Electrical Energy, in Particular for a Motor Vehicle, and a Motor Vehicle Comprising at Least One Such Storage Cell

(71) Applicant: Bayerische Motoren Werke Aktiengesellschaft, Muenchen (DE)

(72) Inventors: Azad DARBANDI, Unterfoehring (DE); Juergen HILDINGER, Hoehenkirchen-Siegertsbrunn (DE); Florian SCHOEWEL, Muenchen (DE)

(21) Appl. No.: 16/687,523

(22) Filed: Nov. 18, 2019

Related U.S. Application Data
(63) Continuation of application No. PCT/EP2018/063235, filed on May 18, 2018.

(30) Foreign Application Priority Data
May 22, 2017 (DE) 10 2017 208 612.2

(51) Int. Cl. H01M 2/26; H01M 10/04; B60R 16/033

(52) U.S. Cl. CPC H01M 2/263; H01M 2220/20; B60R 16/033; H01M 10/0431

(57) ABSTRACT

A storage cell that is configured to store electrical energy includes a cell housing which is prismatic on an outer periphery, and a jelly-roll winding accommodated in the cell housing and which has two opposing broad sides, two opposing first narrow sides and two opposing second narrow sides. The storage cell also includes a first electrode tab which is electrically contacted with a first electrode of the jelly-roll winding and protrudes from the first electrode, and a second electrode tab which is electrically contacted with a second electrode of the jelly-roll winding and protrudes from the second electrode. One of the first and second electrode tabs is arranged on a first one of the two opposing first narrow sides and is electrically connected thereto by a connection element extending from a first one of the two opposing first narrow sides onto a first one of the two opposing second narrow sides.

### CROSS REFERENCE TO RELATED APPLICATIONS

This application is a continuation of PCT International Application No. PCT/EP2018/063235, filed May 18, 2018, which claims priority under 35 U.S.C. § 119 from German Patent Application No. 10 2017 208 612.2, filed May 22, 2017, the entire disclosures of which are herein expressly incorporated by reference.

### BACKGROUND AND SUMMARY OF THE INVENTION

The invention relates to a storage cell for storing electrical energy, in particular for a motor vehicle. Furthermore, the invention relates to a motor vehicle comprising at least one such storage cell.

Such a storage cell for storing electrical energy, in particular for a motor vehicle, can for example already be inferred as known from EP 2 325 927 B1. In this case, the storage cell comprises a cell housing, which is embodied prismatically on the outer side or outer periphery. Moreover, the storage cell comprises at least one electrode winding which is accommodated in the cell housing and which is formed as or by a jelly-roll winding. Such a jelly-roll winding comprises at least one first electrode and at least one second electrode which are wound up or rolled up, in particular about a winding axis, to form said electrode winding. Such a jelly-roll winding usually comprises at least one separator which is arranged between the electrodes and which is wound up with the electrodes to form the electrode winding. The jelly-roll winding is also referred to as a Swiss-roll winding since the jelly-roll winding is an electrode winding which is rolled up or wound up in the manner of a Swiss roll and thus has a so-called Swiss-roll structure.

By virtue of the fact that the jelly-roll winding is wound up or rolled up in the manner of a Swiss roll and thus has a Swiss-roll structure, the jelly-roll winding has two opposing broad sides, two opposing first narrow sides and two opposing second narrow sides. The respective broad sides are arranged for example in respective first planes extending at least substantially parallel to one another. The respective first narrow sides are arranged for example in respective second planes which extend at least substantially parallel to one another and which extend for example perpendicular to the first planes. The second narrow sides are arranged for example in respective third planes which extend at least substantially parallel to one another and which extend for example perpendicular to the first planes and perpendicular to the second planes.

In other words, by way of example, the jelly-roll winding has a first length or width extending along a first direction, in particular spatial direction, a second length or width extending along a second direction, in particular spatial direction, and a third length or width extending along a third direction, in particular spatial direction, wherein the directions or spatial directions extend in each case perpendicular to one another. Here the first length is significantly greater than the second length and the third length, wherein for example the second length and the third length can be identical or wherein for example the third length is greater than the second length.

The storage cell furthermore comprises at least one first electrode tab which for example is at least electrically contacted with or connected to the first electrode of the jelly-roll winding and protrudes from the first electrode. Moreover, the storage cell comprises at least one second electrode tab which is electrically contacted with or connected to the second electrode of the jelly-roll winding and protrudes from the second electrode. The respective electrode tab is also referred to as electrode lug, lug or small lug and is used, for example, in order to be able to electrically contact the electrodes in a simple manner. For this purpose, by way of example, the respective electrode tab, from a location at which the respective electrode tab is electrically contacted with the respective electrode, leads out of the electrode winding mentioned, in particular parallel to the winding axis and thus in an axial direction of the electrode winding.

Moreover, EP 0 948 072 A1 discloses a prismatic battery, comprising a winding embodied as a jelly-roll winding.

It is an object of the present invention to further develop a storage cell and a motor vehicle of the type mentioned in the introduction in such a way that electrical energy can be stored particularly advantageously.

A first aspect of the invention relates to a storage cell for storing electrical energy or electric current, in particular for a motor vehicle. The storage cell is a battery cell, for example. In its fully manufactured state, the motor vehicle comprises a storage device, for example, which can be embodied in particular as a battery, in particular as a high-voltage battery (HV battery). The storage device comprises a plurality of storage cells, for example, which can be embodied in particular as battery cells. The respective storage cells form a storage module, for example.

The storage cell comprises a cell housing, which is embodied prismatically on the outer side or outer periphery. Moreover, the storage cell comprises at least one jelly-roll winding which is accommodated in the cell housing and which has two mutually opposing broad sides, two mutually opposing first narrow sides and two mutually opposing second narrow sides. The jelly-roll winding is a winding that is also referred to as an electrode winding and has a jelly-roll structure, that is to say a Swiss-roll structure. The jelly-roll structure or the Swiss-roll structure should be understood to mean that the electrode winding is wound up in the manner of a Swiss roll (jelly roll).

In this case, the jelly-roll winding comprises a first electrode and a second electrode, which are wound up or rolled up, in particular in the manner of a Swiss roll, and thereby form the Swiss-roll structure. In particular, the electrodes are wound up or rolled up about a winding or rolling axis to form the jelly-roll winding. The jelly-roll winding usually also comprises at least one separator which is arranged between the electrodes and is wound up or rolled up with the latter in the manner of a Swiss roll, thereby forming the Swiss-roll structure. In this case, the respective electrode is formed for example by a strip, that is to say an electrode strip, wherein for example the separator is formed by a strip, in particular by a separator strip.

In this case, the storage cell has at least one first electrode tab which is at least electrically contacted with or connected to the first electrode of the jelly-roll winding and protrudes from the first electrode. Moreover, the storage cell has at least one second electrode tab which is at least electrically contacted with or connected to the second electrode of the jelly-roll winding and protrudes from the second electrode. The respective electrode tab is also referred to as lug, small lug or electrode lug and used for electrically contacting the respective electrode in a particularly simple manner. By way of example, the small lugs protrude from the electrodes along the winding axis and thus in an axial direction of the jelly-roll winding. The cell housing delimits an accommodating space, for example, in which the jelly-roll winding is accommodated. In this case, the accommodating space is also referred to as interior or cell interior.

In order then to be able to store electrical energy or electric current particularly advantageously, in particular efficiently and effectively, by means of the storage cell, the invention provides for at least one of the electrode tabs to be arranged on one of the first narrow sides and to be at least electrically connected there to a connection element extending from said one first narrow side onto one of the second narrow sides. As a result, for example, for given external dimensions of the storage cell or of the cell housing, the accommodating space can be utilized particularly efficiently and effectively, such that, for example, the structural space requirement of the storage cell can be kept particularly small, wherein at the same time a particularly large amount of electrical energy can be stored in the storage cell. The described configuration of the storage cell enables a particularly advantageous arrangement of the jelly-roll winding, also referred to as winding or electrode winding, together with the arrangement and positioning of the electrode tabs, also referred to as small electrode lugs, such that, for example, a particularly high storage capacity for storing electrical energy can be realized. In comparison with conventional storage cells, in the case of the storage cell according to the invention, an energetically more efficient spatial utilization can be realized, in particular vis-à-vis the use of electrode stacks. In this case, the invention is based on the insight that the use of electrode stack methods leads to a complex and thus cost-intensive production of the storage cell on account of doubled production cycle time, which can be avoided in the case of the storage cell according to the invention. Consequently, the storage cell according to the invention can be produced particularly simply and cost-effectively.

Moreover, the described configuration of the storage cell according to the invention makes it possible to provide sufficient area for the implementation of advantageous functions, such as, for example, of a safety device, in particular on a side of the cell housing. Such a safety device is a degassing unit, for example, via which a fluid that arises in the cell housing can be carried away from the cell housing.

Furthermore, it is possible to provide a sufficiently large area for the implementation of so-called terminals, wherein such a terminal is for example a terminal via which electric current stored in the storage cell can be carried away from the storage cell. Furthermore, the degassing unit can be positioned particularly advantageously in order to carry away the fluid particularly advantageously from the accommodating space and thus from the cell housing.

The fluid arises for example owing to an accident-dictated application of force to the storage cell, wherein the fluid is for example a gas or a gas flow. As the amount of fluid released in the accommodating space increases, a pressure prevailing in the accommodating space or in the cell housing rises, said pressure also being referred to as internal pressure. If the pressure exceeds a predefinable limit or threshold value, then the degassing unit releases at least one outlet opening, for example. Via the outlet opening being released, at least part of the fluid initially accommodated in the accommodating space can flow out of the accommodating space, in particular to the surroundings of the cell housing, as a result of which an excessive rise in the pressure prevailing in the accommodating space can be avoided. Particularly safe operation is able to be realized as a consequence.

In order to be able to realize a particularly high energy efficiency of the storage cell, one advantageous embodiment of the invention provides for the connection element to end on said one second narrow side.

A further embodiment is distinguished by the fact that the respective other electrode tab is arranged on said one first narrow side and is electrically connected there to a second connection element extending from said one first narrow side onto said one second narrow side. As a result, the accommodating space can be utilized particularly effectively and efficiently, such that in conjunction with small external dimensions and thus a small structural space requirement being realized simultaneously, a particularly large amount of electrical energy can be stored in the storage cell.

In an advantageous configuration of the invention, the respective other electrode tab is arranged on the respective other first narrow side and is electrically connected there to a second connection element extending from the other first narrow side onto said one second narrow side. A particularly high energy efficiency can be realized as a result.

In order that the accommodating space available for given external dimensions, for example, can be utilized particularly energy-efficiently, an advantageous configuration of the invention provides for the second connection element to end on said one second narrow side.

A further, particularly advantageous embodiment provides for the respective other electrode tab to be arranged on said one first narrow side and to be at least electrically connected there to a second connection element extending from said one first narrow side onto the respective other second narrow side. A particularly high energy efficiency can be realized as a result.

In order, for given external dimensions, for example, to be able to store a particularly large amount of electrical energy by means of the storage cell, a further configuration of the invention provides for the respective other electrode tab to be arranged on the other first narrow side and to be electrically connected there to a second connection element extending from the other first narrow side onto the other second narrow side.

In this case, it has been found to be particularly advantageous if the second connection element ends on the other second narrow side. As a result, the accommodating space can be utilized particularly efficiently and effectively for storing electrical energy.

By way of example, an, in particular liquid, electrolyte is arranged in the accommodating space and thus in the cell housing, said electrolyte being utilized for storing electrical energy. In this case, by way of example, the fluid mentioned above can arise from the electrolyte, in particular owing to an accident-dictated application of force to the storage cell. By way of example, the fluid arises from the electrolyte by virtue of the electrolyte being heated, in particular owing to the accident-dictated application of force.

In order to realize a particularly efficient and effective storage of electrical energy, a further embodiment of the invention provides for the respective connection element to be electrically connected to a respective terminal arranged on the same narrow side as the respective connection element, and arranged at least partly on an outer side of the cell housing facing away from the accommodating space, via which terminal the electrical energy stored by means of the storage cell is able to be carried away from the storage cell. The terminal is the abovementioned terminal via which the storage cell can provide the electrical energy stored by means of the storage cell. By way of example, a first part of the terminal is arranged in the accommodating space or on an inner side of the cell housing facing away from the outer side and facing the accommodating space, such that the connection element, in particular in the accommodating space, is at least electrically, preferably electrically and mechanically, connected to the first part and thus to the terminal. Via the second part, for example, the electrical energy stored in the storage cell can then be passed from the accommodating space to the surroundings of the storage cell and be carried away from the latter. The mechanical connection should be understood to mean, for example, that the connection element is held at the terminal.

If, by way of example, the storage device mentioned above comprises a plurality of storage cells, then the latter are electrically connected to one another via their respective terminals, for example, wherein the storage cells can be connected in parallel or in series with one another, for example. As a result, it is possible to provide for example particularly large electrical powers for driving the motor vehicle mentioned. In particular, the storage device can thereby provide for example an electrical voltage, in particular an electrical operating voltage, of more than 50 volts, in particular of more than 60 volts and preferably of hundreds of volts, such that the storage device is preferably embodied as a high-voltage component, in particular as a high-voltage battery.

The connection element is embodied as a so-called soft connector, for example. By way of example, in particular in the context of production of the storage cell, the soft connector can be deformed, in particular bent or bowed, manually, that is to say by a person, elastically or plastically and nondestructively in the process, such that the soft connector can be electrically and preferably also mechanically connected to the respective terminal particularly simply and thus time- and cost-effectively.

In this case, it has been found to be particularly advantageous if the connection element (soft connector) is formed by a foil or embodied as a foil.

Preferably, the connection element, in particular the foil, is formed from a metallic material, in particular from aluminum, such that the connection element is formed by an aluminum foil, for example.

If for example two or more electrode windings, in particular in the form of jelly-roll windings, are arranged in the cell housing, then a common connection element can be used for example for at least one of the electrode tabs of a first of the jelly-roll windings and for at least one of the electrode tabs of a second of the jelly-roll windings, which connection element is electrically and preferably also mechanically connected for example firstly to the electrode tab of the first jelly-roll winding and the electrode tab of the second jelly-roll windings and secondly to a terminal of the storage cell, such that at least the two electrode tabs of the jelly-roll windings are electrically contacted with the terminal common to the electrode tabs via the connection element common to said electrode tabs. As a result, for example, the number of components installed in the cell housing can be kept particularly small, such that the accommodating space can be used particularly energy-efficiently.

The use of the soft connector makes it possible to realize particularly thick storage cells, as a result of which for example particularly advantageous cooling of the storage cell can be produced. If for example the connection elements are positioned on the same side or the connection elements end on the same side, for example, then the accommodating space can be used particularly advantageously.

A second aspect of the invention relates to a motor vehicle, in particular an automobile such as a car, for example. The motor vehicle in this case comprises at least one storage device comprising at least one storage cell according to the invention. Advantages and advantageous configurations of the first aspect of the invention should be regarded as advantages and advantageous configurations of the second aspect of the invention, and vice-versa.

Further details of the invention are evident from the following description of preferred exemplary embodiments with the associated drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic perspective view of a storage cell according to the invention in accordance with a first embodiment.

FIG. 2 shows a schematic perspective view of a jelly-roll winding of the storage cell in accordance with FIG. 1.

FIG. 3 shows a schematic perspective view of the jelly-roll winding in accordance with a second embodiment.

FIG. 4 shows a schematic perspective view of the storage cell in accordance with a third embodiment.

FIG. 5 shows a schematic perspective view of the jelly-roll winding of the storage cell in accordance with FIG. 4.

### DETAILED DESCRIPTION OF THE DRAWINGS

In the figures, identical or functionally identical elements are provided with identical reference signs.

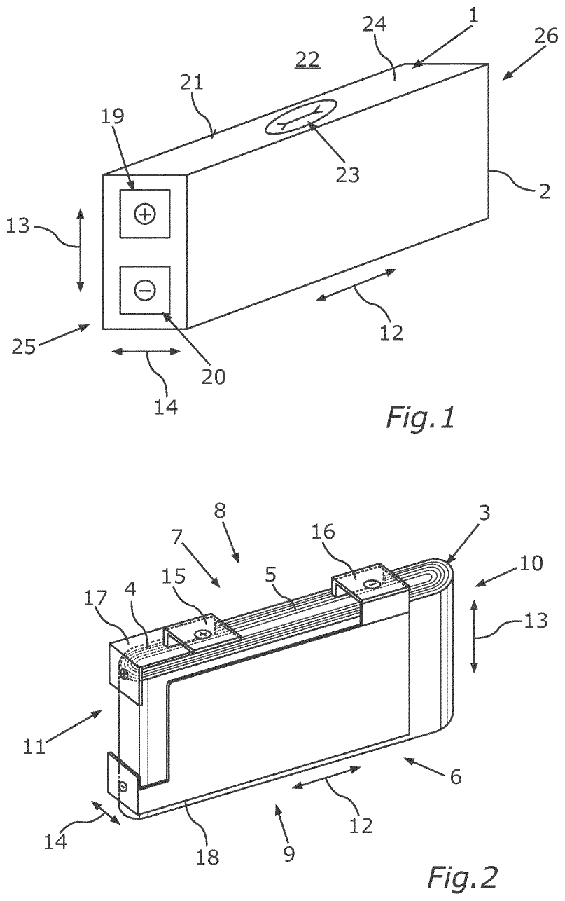

FIG. 1 shows, in a schematic perspective view, a first embodiment of a storage cell 1 for storing electrical energy or electric current. The storage cell 1 is used for example for a motor vehicle, in particular for an automobile such as a car, for example. In its fully manufactured state, the motor vehicle comprises for example a storage device having at least one module. The module comprises a plurality of storage cells 1, for example. The respective storage cell 1 is embodied as a battery cell, for example, such that the storage device is embodied as a battery, for example. In particular, the storage device is embodied as a high-voltage component, in particular as a high-voltage battery (HV battery).

The storage cell 1 comprises a cell housing 2, which is embodied prismatically on the outer side or outer periphery. In this case, the cell housing 2 forms or delimits an accommodating space, not illustrated in more specific detail in the figures, said accommodating space also being referred to as interior or cell interior. The storage cell 1 furthermore comprises a jelly-roll winding 3 arranged in said accommodating space and thus in the cell housing 2, said jelly-roll winding being shown in a schematic perspective view in FIG. 2. The jelly-roll winding 3 is also referred to simply as winding and is an electrode winding which is rolled up or wound up in the manner of a Swiss roll, that is to say in the manner of a jelly roll, and thus has a jelly-roll structure, that is to say a Swiss-roll structure.

The jelly-roll winding 3 has a first electrode 4 and a second electrode 5. The electrode 4 is embodied as a cathode, for example, wherein the electrode 5 is embodied as an anode, for example. Furthermore, the jelly-roll winding 3 comprises for example a separator, not discernible in more specific detail in the figures, which separator is wound up or rolled up together with the electrodes 4 and 5 in the manner of a Swiss roll to form the jelly-roll winding 3. In this case, the electrodes 4 and 5 and the separator are formed for example by respective strips, that is to say by electrode strips and separator strips.

Since the electrode winding has the Swiss-roll structure, the jelly-roll winding 3 has two mutually opposing broad sides 6 and 7, two mutually opposing first narrow sides 8 and 9, and two mutually opposing second narrow sides 10 and 11. The electrodes 4 and 5 are wound up or rolled up around a winding or rolling axis, for example. The broad sides 6 and 7 are arranged for example in respective first planes extending at least substantially parallel to one another, wherein the first planes extend for example at least substantially parallel to the winding axis. The narrow sides 8 and 9 are arranged for example in respective second planes extending at least substantially parallel to one another and extending for example perpendicular to said winding axis and perpendicular to the first planes. The respective narrow sides 10 and 11 are arranged for example in respective third planes extending at least substantially parallel to one another and extending for example at least substantially parallel to the winding axis and in this case perpendicular to the first planes and perpendicular to the second planes.

In order to avoid an excessive structural space requirement of the storage cell 1, the accommodating space is utilized efficiently, such that for example the cell housing 2 has a shape adapted to the jelly-roll winding 3. Furthermore, the cell housing 2 and the jelly-roll winding 3 have a first length and first width, respectively, extending along a first direction, wherein the first direction is illustrated by a double-headed arrow 12 in FIGS. 1 and 2. Furthermore, the cell housing 2 and the jelly-roll winding 3 have a second length and second width, respectively, extending along a second direction, wherein the second direction is illustrated by a double-headed arrow 13. Furthermore, the cell housing 2 and the jelly-roll winding 3 have a third length and third width, respectively, extending along a third direction, wherein the third direction is illustrated by a double-headed arrow 14. The directions illustrated by the double-headed arrow 12, 13 and 14 are respective spatial directions which, in particular in pairs, extend perpendicular to one another. In this case, for example, the second direction extends parallel to the winding axis or coincides therewith. The respective first plane mentioned above is spanned for example by the first direction and by the second direction. The respective second plane mentioned above is spanned for example by the first direction and the third direction. The respective third plane mentioned above is spanned for example by the second direction and by the third direction.

Furthermore, the first length is significantly greater than the second length and the third length, wherein the second length and the third length can be identical. In the exemplary embodiment illustrated in FIGS. 1 and 2, however, the second length is greater than the third length. The jelly-roll winding 3 and respectively the cell housing 2 thus have an at least substantially rectangular cross section in the third plane.

The storage cell 1 furthermore comprises a first electrode tab 15, which is electrically and mechanically connected to the electrode 4. The electrode tab 15 is thus electrically with the electrode 4. Moreover, the storage cell 1 comprises an electrode tab 16 that is electrically and mechanically connected to the electrode 5. Consequently, the electrode tab 16 is electrically contacted with the electrode 5. Since the electrode 4 is a cathode, the electrode tab 15, for example, is an electrical positive pole. Since the electrode 5 is an anode, for example, the electrode tab 16 is an electrical negative pole, for example. The respective electrode tab 15 and 16 is also referred to as small lug, lug or electrode lug and protrudes from the respective electrode 4 and 5, in particular along or parallel to the winding axis and thus for example in an axial direction of the jelly-roll winding 3. As a result, the electrodes 4 and 5 can be electrically contacted via the electrode tabs 15 and 16 particularly simply despite the circumstance that the electrode winding has the jelly-roll structure.

In order then to be able to store electrical energy or electric current particularly advantageously and in particular efficiently and effectively by means of the storage cell 1, the electrode tab 15 is arranged on the narrow side 8 and is electrically and mechanically connected there to a first connection element 17, which extends from the narrow side 8 to the narrow side 11 and ends there. Consequently, the connection element 17 is also a positive pole of the jelly-roll winding 3.

In the first embodiment illustrated in FIGS. 1 and 2, the electrode tab 16 is also arranged on the narrow side 8 and is electrically and mechanically connected there to a second connection element 18, which likewise extends from the narrow side 8 to the narrow side 11 and ends there. Consequently, the second connection element 18 is also a negative pole.

It is evident in joint consideration with FIG. 1 that respective terminals 19 and 20 of the storage cell 1 are arranged on the same narrow side 11 on which the connection elements 17 and 18 end. In this case, the respective terminal 19 and 20 is arranged at least partly on an outer side 21 of the cell housing 2 facing away from the accommodating space. In this case, the connection element 17, in particular in the accommodating space, is electrically and mechanically connected to the terminal 19, such that the terminal 19 is an electrical positive pole of the storage cell 1. The connection element 18, in particular in the accommodating space, is electrically and mechanically connected to the terminal 20, such that the terminal 20 is an electrical negative pole of the storage cell 1. The terminals are thus arranged for example partly in the accommodating space and partly on the outer side 21 of the cell housing 2 facing away from the accommodating space, and thus in the surroundings 22 of said cell housing. As a result, via the terminals 19 and 20, the storage cell 1 can provide the electrical energy stored by means of the storage cell 1, such that the electrical energy stored by means of the storage cell 1 can be carried away from the storage cell 1 via the terminals 19 and 20. In other words, it is possible to electrically connect a component arranged in the surroundings 22, such as a further storage cell, for example, to the terminals 19 and 20, such that components arranged in the surroundings can be electrically connected to the jelly-roll winding 3 via the terminals 19 and 20.

The respective connection element 17 and 18 is preferably embodied as a soft connector. For this purpose, provision is preferably made for the respective connection element 17 and 18 to be formed from a metallic foil, in particular from aluminum foil. During production of the storage cell 1, for example, the respective connection element 17 and 18, by virtue of its being embodied as a soft connector, can be nondestructively deformed, in particular bent or bowed, by a person manually and thus without a tool, such that the person can connect the connection elements 17 and 18 to the terminals 19 and 20, in particular in said accommodating space, in a particularly simple and thus time- and cost-effective manner. As a result, the storage cell 1 can be produced particularly time- and cost-effectively.

The storage cell 1 furthermore comprises a degassing unit 23, by means of which a fluid released in the accommodating space, in particular a gas, can be carried away from the accommodating space and in particular to the surroundings 22. In the first embodiment, the degassing unit 23 is provided on a wall 24 of the cell housing 2. Preferably, in the installation position of the storage cell 1, the accommodating space is upwardly delimited at least partly, in particular at least predominantly or completely, by the wall 24, wherein the storage cell 1 assumes its installation position for example in the fully produced state installed in the motor vehicle, for example. Consequently, for example, the storage cell 1 assumes its installation position in the fully manufactured state of the motor vehicle, such that the accommodating space is upwardly delimited at least partly, in particular at least predominantly or completely, by the wall 24 in the vertical direction or in the vehicle's vertical direction relative to the installation position.

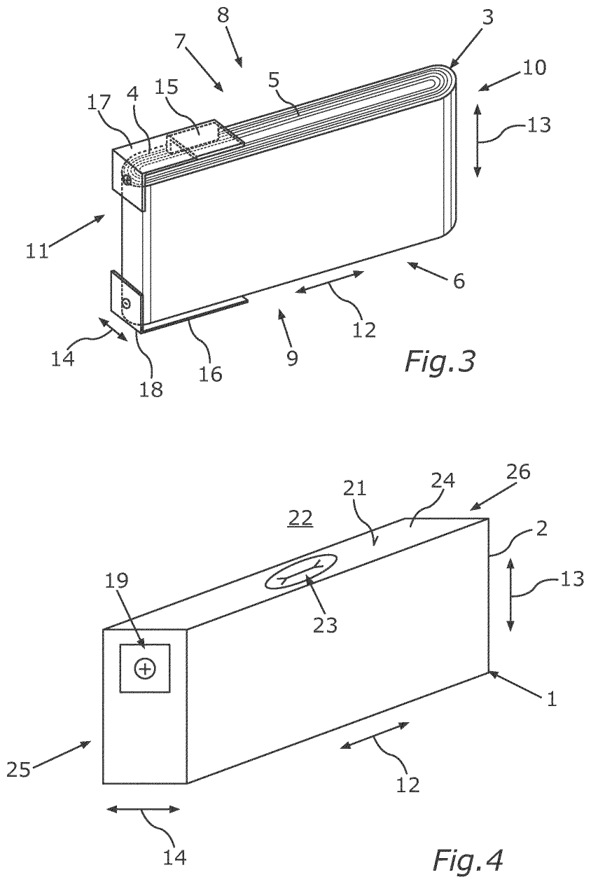

FIG. 3 illustrates a second embodiment of the jelly-roll winding 3 and thus of the storage cell 1 overall. In the second embodiment, the electrode tab 16 is arranged on the narrow side 9 opposite the narrow side 8 and is electrically and mechanically connected there to the second connection element 18, which extends from the narrow side 9 to the narrow side 11 to which the connection element 17 extends as well. In the second embodiment, too, the connection element 18 ends on the narrow side 11.

It is evident from FIGS. 1 to 3 that the connection elements 17 and 18 end on the same narrow side 11 and are thus arranged on the same narrow side 11, as a result of which the accommodating space can be used particularly effectively and efficiently for storing electrical energy. While the electrode tabs 15 and 16 are arranged on the same narrow side 8 in the first embodiment, the electrode tabs 15 and 16 are arranged on the opposing narrow sides 8 and 9 in the second embodiment.

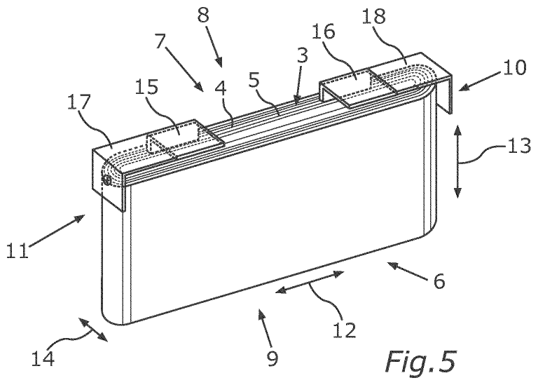

Finally, FIGS. 4 and 5 illustrate a third embodiment of the storage cell 1. In the third embodiment, the electrode tabs 15 and 16 are arranged on the same narrow side 8, as in the first embodiment. In this case, the connection element 17 extends from the narrow side 8 to the narrow side 11. However, the connection element 18 extends from the narrow side 8 to the narrow side 10 opposite the narrow side 11 and ends there.

While in the first embodiment and in the second embodiment the terminals 19 and 20 are arranged on the same narrow side 25 of the cell housing 2, which is prismatic on the outer periphery, in the third embodiment—as is evident from FIG. 4—the terminal 19 is arranged on the narrow side 25, while the terminal 20, not discernible in FIGS. 4 and 5, is arranged on a narrow side 26 of the cell housing 2 that is opposite the narrow side 25. Consequently, whereas in the first and second embodiments, for example, the connection elements 17 and 18 and the terminals 19 and 20 are arranged on the same narrow side 11 or 25, in the third embodiment the terminal 19 and the connection element 17 are arranged on the same narrow side 11 or 25, while the terminal 20 and the connection element 18 are arranged on the same narrow side 10 or 26 opposite the narrow side 11 or 25, respectively.

### LIST OF REFERENCE SIGNS

1 Storage cell
2 Cell housing
3 Jelly-roll winding
4 Electrode
5 Electrode
6 Broad side
7 Broad side
8 Narrow side
9 Narrow side
10 Narrow side
11 Narrow side
12 Double-headed arrow
13 Double-headed arrow
14 Double-headed arrow
15 Electrode tab
16 Electrode tab
17 Connection element
18 Connection element
19 Terminal
20 Terminal
21 Outer side
22 Surroundings
23 Degassing unit
24 Wall
25 Narrow side
26 Narrow side

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A storage cell configured to store electrical energy, comprising:
a cell housing which is prismatic on an outer periphery;
a jelly-roll winding accommodated in the cell housing and which has two opposing broad sides, two opposing first narrow sides and two opposing second narrow sides;
a first electrode tab which is electrically contacted with a first electrode of the jelly-roll winding and protrudes from the first electrode; and
a second electrode tab which is electrically contacted with a second electrode of the jelly-roll winding and protrudes from the second electrode,
wherein one of the first and second electrode tabs is arranged on a first one of the two opposing first narrow sides and is electrically connected thereto by a connection element extending from a first one of the two opposing first narrow sides onto a first one of the two opposing second narrow sides.

2. The storage cell according to claim 1, wherein the connection element ends on said first one of the two opposing second narrow sides.

3. The storage cell according to claim 1, wherein the other of the first and second electrode tabs is arranged on said first one of the two opposing first narrow sides and is electrically connected thereto by a second connection element extending from said first one of the two opposing first narrow sides onto said first one of the two opposing second narrow sides.

4. The storage cell according to claim 2, wherein the other of the first and second electrode tabs is arranged on said first one of the two opposing first narrow sides and is electrically connected thereto by a second connection element extending from said first one of the two opposing first narrow sides onto said first one of the two opposing second narrow sides.

5. The storage cell according to claim 1, wherein the other of the first and second electrode tabs is arranged on a second one of the two opposing first narrow sides and is electrically connected thereto by a second connection element extending from a second one of the two opposing first narrow sided onto said first one of the two opposing second narrow sides.

6. The storage cell according to claim 2, wherein the other of the first and second electrode tabs is arranged on a second one of the two opposing first narrow sides and is electrically connected thereto by a second connection element extending from a second one of the two opposing first narrow sided onto said first one of the two opposing second narrow sides.

7. The storage cell according to claim 3, wherein the second connection element ends on said first one of the two opposing second narrow sides.

8. The storage cell according to claim 5, wherein the second connection element ends on said first one of the two opposing second narrow sides.

9. The storage cell according to claim 2,
wherein the other of the first and second electrode tabs is arranged on said first one of the two opposing first narrow sides and is electrically connected thereto by a second connection element extending from said first one of the two opposing first narrow sides onto a second one of the two opposing second narrow sides.

10. The storage cell according to claim 2,
wherein the other of the first and second electrode tabs is arranged on
a second one of the two opposing first narrow sides and is electrically connected thereto by a second connection element extending from the second one of the two opposing first narrow sides onto a second one of the two opposing second narrow sides.

11. The storage cell according to claim 9, wherein the second connection element ends on the second one of the two opposing second narrow sides.

12. The storage cell according to claim 10, wherein the second connection element ends on the second one of the two opposing second narrow sides.

13. The storage cell according to claim 1,
wherein the connection element is electrically connected to a terminal arranged on one of the two opposing first narrow sides on which the connection element ends, and arranged at least partly on an outer side of the cell housing facing away from the jelly-roll winding, via which terminal the electrical energy stored by the storage cell is carried away from the storage cell.

14. The storage cell according to claim 1, wherein the connection element is formed by a foil.

15. The storage cell according to claim 1, wherein the connection element is formed from aluminum.

16. A motor vehicle, comprising at least one storage device having at least one storage cell, wherein the storage cell is configured to store electrical energy and wherein the storage cell comprises:
a cell housing which is prismatic on an outer periphery;
a jelly-roll winding accommodated in the cell housing and which has two opposing broad sides, two opposing first narrow sides and two opposing second narrow sides;
a first electrode tab which is electrically contacted with a first electrode of the jelly-roll winding and protrudes from the first electrode; and
a second electrode tab which is electrically contacted with a second electrode of the jelly-roll winding and protrudes from the second electrode,
wherein one of the first and second electrode tabs is arranged on a first one of the two opposing first narrow sides and is electrically connected thereto by a connection element extending from a first one of the two opposing first narrow sides onto a first one of the two opposing second narrow sides.
